(19) United States
(12) Patent Application Publication
(10) Pub. No.: US 2026/0296306 A1
(43) Pub. Date: Oct. 1, 2026

(54) ILLUMINATION DEVICE AND STEERING DEVICE USING THE SAME

(71) Applicant: TOYODA GOSEI CO., LTD., Kiyosu-shi (JP)

(72) Inventors: Kazuma MURAMATSU, Aichi (JP); Akitoshi NAGANAWA, Aichi (JP)

(21) Appl. No.: 19/549,574

(22) Filed: Feb. 25, 2026

(30) Foreign Application Priority Data
Mar. 26, 2025 (JP) 2025-051342

(51) Int. Cl. B60Q 3/66; B60Q 3/283; B62D 1/06; F21V 8/00

(52) U.S. Cl. CPC B60Q 3/66; B60Q 3/283; G02B 6/0036; G02B 6/0068; B62D 1/06

(57) ABSTRACT

An illumination device for emitting light in directions centered on a first direction includes: a light source configured to emit light centered on a second direction; and a light guiding path that includes a boundary surface reflecting the light toward the first direction. In the boundary surface, a first angle serving as an incident angle at a first point on the boundary surface satisfies a total reflection condition. An angle formed by a normal line on the boundary surface with respect to the second direction is defined as an inclination angle. For light inclined by a predetermined displacement angle being reflected among the light emitted from the light source, a second angle serving as the inclination angle formed at a second point on the boundary surface is smaller than the first angle, and a deviation between the first and second angles is equal to or less than the displacement angle.

### CROSS-REFERENCE TO RELATED APPLICATIONS

This application is based upon and claims the benefit of priority from prior Japanese patent application No. 2025-051342, filed on Mar. 26, 2025, the entire contents of which are incorporated herein by reference.

### TECHNICAL FIELD

The present disclosure relates to an illumination device used in a vehicle cabin.

### BACKGROUND ART

There has been proposed an illumination device, such as a steering device (also referred to as a steering wheel), which is provided in a vehicle cabin and is used for decoration by light, information display, and the like (for example, see JP7327321B). In such an illumination device, light from a light source such as an LED is guided to a location away from the light source with a light guiding path using a light transmitting member such as acrylic.

### SUMMARY

In order to efficiently guide the light from the light source to the use location, it is generally desirable to shorten the light guiding path and linearly arrange the light guiding path, but the light may be reflected in the light guiding path depending on the arrangement of the light source and the use location, an attachment position of the light source, and the like. In such a case, a part of the light may leak out of the light guiding path depending on an angle of the light incident on the light guiding path, which may cause problems such as a decrease in light guide efficiency and an unevenness in brightness at the use location.

According to an aspect of the present disclosure, there is provided an illumination device (200) for emitting light in directions centered on a first direction (D1), the illumination device including:
a light source (32 and 33) configured to emit light centered on a second direction (D2), the second direction being different from the first direction; and
a light guiding path (20) on which the light from the light source is incident that includes, at a part of an outer periphery thereof on a side opposite to the light source, a boundary surface (HM) reflecting the light incident in the second direction toward the first direction, in which
in the boundary surface by which the light emitted from the light source in the second direction is reflected toward the first direction,
a first angle (θ1) serving as an incident angle at a first point (P1) on the boundary surface satisfies a total reflection condition,
an angle formed by a normal line (NL) on the boundary surface with respect to the second direction is defined as an inclination angle, and
for light inclined by a predetermined displacement angle (Δα) from the second direction toward the first direction being reflected by the boundary surface toward the first direction among the light emitted from the light source, a second angle (θ2) serving as the inclination angle formed at a second point (P2) on the boundary surface is smaller than the first angle, and a deviation (Δθ) between the first angle and the second angle is equal to or less than the displacement angle.

According to another aspect of the present disclosure, there is provided an illumination device (200) for emitting light in directions centered on a first direction (D1), the illumination device including:
a light source (32, 33) configured to emit light centered on a second direction (D2) different from the first direction; and
a light guiding path (20) on which the light from the light source is incident that includes, at a part of an outer periphery thereof on a side opposite to the light source, a boundary surface (HM) reflecting the light incident in the second direction toward the first direction, in which
in the boundary surface by which the light emitted from the light source in the second direction is reflected toward the first direction, a first angle (θ1) serving as an incident angle at a first point (P1) on the boundary surface satisfies a total reflection condition, and
at least a part of a connecting shape portion (28) located on a side opposite to the boundary surface at a part of the outer periphery of the light guiding path has a shape that is inclined and connected from the second direction toward the first direction.

According to another aspect of the present disclosure, there is provided a steering device (100) including:
a substantially circular handle (110) configured to be used to perform a steering operation, and
the illumination device (200), in which
the first direction is a direction from the handle toward a user who performs the steering operation,
the second direction is a radial direction toward the outside of the handle, and
the third direction is a circumferential direction of the handle.

In the present specification, the terms generally follow the following definitions. When any term is used out of the following definitions, the term will be described. Light: not only visible light but also electromagnetic waves (infrared rays) up to far-infrared rays on a longer wavelength side and near-ultraviolet electromagnetic waves (near ultraviolet rays) on a short wavelength side are included. Regarding a wavelength region, electromagnetic waves of about 10 μm to 200 nm are collectively referred to as light. In some cases, the infrared rays and ultraviolet rays may be respectively referred to as infrared light and ultraviolet light.

Light source: a mechanism that emits light. There is no limitation on the mechanism of light emission, such as a light bulb, an LED, or an organic EL.

Light emission: The light source emits light. The presence or absence of the directivity, a degree, an intensity, a wavelength, and the like for the light emission are not limited.

Emission: light is emitted with a predetermined directivity from a relatively narrow region such as a point light source or a small hole.

Incidence: light reaches a boundary surface with the outside of an object. In the present specification, the term “incidence” may refer to a case in which the light enters the inside of the object through the boundary surface, and is paired with the term “exit”.

Exit: This term indicates a case in which light inside the object exits to the outside of the object through the boundary surface with the outside, and is paired with the term “incidence”.

Exiting light: light running in a specific direction among the light exiting from the object.

Incident light: light running from a specific direction toward an object and entering the inside of the object.

Radiation and emanation: A case in which an object emits particle beams or electromagnetic waves including light is referred to as “radiation. Radiation of the electromagnetic waves including light is referred to as “emanation”. A case in which heat is transferred to the outside by radiation may be referred to as “thermal radiation”, and in particular, heat transferred by emanation of electromagnetic waves may be referred to as “radiant heat”.

Illumination: Brightness and hue in a certain area are changed by light. The change in the brightness and hue includes a case in which the change corresponds to transmission of some information, a case in which the change is decorative, a case in which illumination or irradiation by light is intended, and the like.

### BRIEF DESCRIPTION OF DRAWINGS

Exemplary embodiment(s) of the present invention will be described in detail based on the following figures, wherein:

FIG. 1 is a plan view showing an external shape of a steering device in a state in which a transmission component as an embodiment is attached;

FIG. 2 is a plan view showing an external shape of the steering device in a state in which a cover member, a light guiding member, and a housing member are removed;

FIG. 3 is a first exploded perspective view showing a detailed configuration of an illumination device assembled as an electrical component;

FIG. 4 is a second exploded perspective view showing the detailed configuration of the illumination device;

FIG. 5 is an explanatory diagram showing the arrangement of the light guiding member in a cross section taken along a V-V line in the steering device shown in FIG. 2;

FIG. 6 is an explanatory diagram showing a structure of the light guiding member and a light path;

FIG. 7 is an explanatory diagram schematically showing a state of reflection at the light path and a boundary surface;

FIG. 8 is a view taken along an arrow VIII in FIG. 6;

FIG. 9 is a view taken along an arrow IX in FIG. 6;

FIGS. 10A and 10B are explanatory diagrams showing a shape of a scattering and reflecting portion and a scattered state of light; and

FIG. 11 is an explanatory diagram illustrating a shape of the light guiding member functioning as a light guiding path.

### DESCRIPTION OF EMBODIMENTS

### A. First Embodiment (A1) Overall Configuration of Steering Device 100

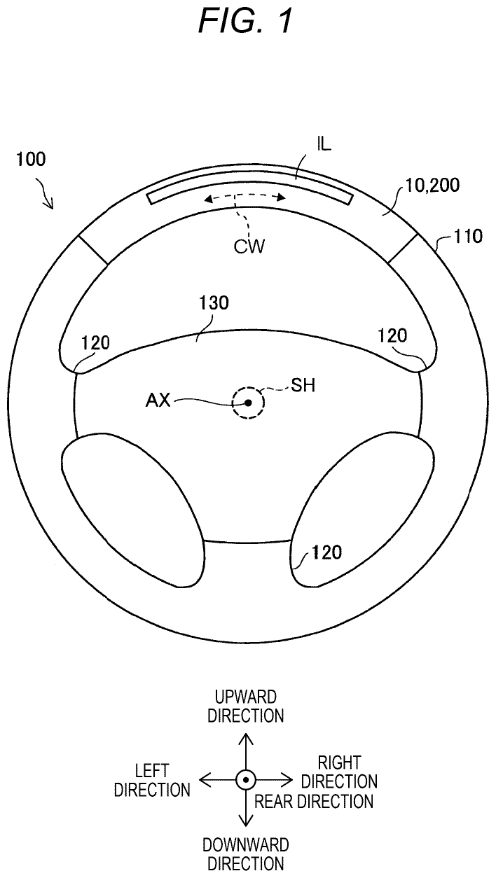

FIG. 1 is a plan view showing an external shape of a steering device 100 in a state in which an illumination device 200 as an embodiment of the present disclosure is attached. The steering device 100 is disposed in a driver's seat area of a vehicle and is used by a driver. Examples of the vehicle include a vehicle equipped with an engine, a hybrid vehicle (HEV), a plug-in hybrid vehicle (PHEV), a battery electric vehicle (BEV), and a fuel cell vehicle (FCV). Needless to say, the present disclosure is not limited to the vehicle, and can be applied to a steering device of a moving body such as a senior car, a two-wheeled vehicle, or a ship.

The steering device 100 is a part of a steering apparatus that is operated by the driver of the vehicle. FIG. 1 shows the steering device 100 in a state of being coupled to a steering shaft SH in the vehicle and causing the vehicle to travel straight (hereinafter, also referred to as a “reference state”). FIG. 1 shows an external configuration of the steering device 100 on a side facing the driver (a “rear” side to be described later). The steering device 100 is configured to enable a rotation operation about an axis AX of the steering shaft SH. The rotation of the steering device 100 is transmitted to a steering gear box (not shown) via the steering shaft SH. The steering device 100 according to the present embodiment has a substantially annular shape as a whole, but may be any shape such as a polygonal shape and an elliptical shape instead of the substantially annular shape, and may be a non-symmetrical shape such as a so-called D shape. Further, the shape of a portion to be gripped to steer the steering device 100 is not limited to the annular shape, and may be any shape formed by a plurality of parts provided at positions separated from each other.

In the present embodiment, a direction along the axis AX of the steering shaft SH is referred to as a “front-rear direction” (a front direction and a rear direction) in association with a traveling direction of the vehicle. Among directions orthogonal to the axis AX, a direction overlapping with a vertical direction (a vertically upward direction and a vertically downward direction) when viewed by the driver is referred to as an “upward-downward direction”. Among the directions orthogonal to the axis AX, a direction parallel to left and right directions (a width direction) of the vehicle is referred to as a “left-right direction”. At this time, the left and right directions coincide with directions when viewed from the driver's seat.

The steering device 100 is rotated clockwise or counterclockwise when viewed from a driver's seat side for steering. Therefore, in the following description, when the arrangement or the like of each component in the steering device 100 is described by using the terms “upward-downward direction” and “left-right direction”, each direction is referred to by assuming that the steering device 100 is in the reference state. The “front-rear direction” does not change depending on a steering state of the steering device 100.

The steering device 100 includes a ring-shaped grip portion 110, a boss portion 130 disposed at a substantially central portion of the grip portion 110, three spoke portions 120, and the illumination device 200 serving as an electrical component and disposed at a part of the grip portion 110. As described below, the illumination device 200 is provided with light emitting elements such as LEDs as a light source, light from the light emitting element is guided inside the illumination device 200, and the illumination device 200 can be visually recognized from the outside in a partial region of the grip portion 110. This region is referred to as an illumination region IL.

The grip portion 110 is gripped by the driver when the steering device 100 is operated. Since the grip portion 110 is a portion gripped by the driver, the grip portion 110 may be referred to as a “handle” or a “handle member”. In the present embodiment, the grip portion 110 has a substantially annular shape. A center axis of the grip portion 110 coincides with the axis AX of the steering shaft SH. The arrangement of the components in the illumination device 200 disposed inside the grip portion 110 follows the shape of the grip portion 110. Therefore, a direction along the annular shape of the substantially annular grip portion 110 may be referred to as an annular direction CW in the following description. The annular direction CW is shown in FIG. 1 for convenience of drawing.

As described below, the grip portion 110 according to the present embodiment is configured by stacking a plurality of members in a thickness direction. The outermost layer is formed by an outer skin layer (an outer skin layer 80 to be described later) formed of a leather member. Although not shown in FIG. 1, in the grip portion 110, a recess (a recess C1 to be described later) that accommodates a part of the illumination device 200 is formed in a part of the grip portion 110 on the upper side in the reference state. The part of the illumination device 200 is accommodated in the recess C1. In other words, the illumination device 200 is fitted into the recess C1. Further, an opening of the recess C1 is closed by the illumination device 200.

The three spoke portions 120 couple the grip portion 110 and the boss portion 130. The boss portion 130 corresponds to a connection portion when the steering device 100 is connected to the steering shaft SH. A folded air bag and an inflator, which are not shown, are accommodated in the boss portion 130. Further, a temperature control circuit constituting a heater, and various sensor devices such as a sensor for detecting room temperature and a sensor for detecting gripping of the grip portion 110 by a user, may be accommodated in the boss portion 130. The three spoke portions 120 and the boss portion 130 may be provided with various operation buttons for operating a navigation device, an audio device, and the like mounted on the vehicle.

The illumination device 200 includes the light source that emits light. In the present embodiment, the light emitted from the light source of the illumination device 200 includes visible light and infrared rays (infrared light). The illumination device 200 can notify the driver of various information by changing brightness of the visible light in the illumination region IL. For example, the illumination device 200 can notify the driver of some information by changing the brightness of the entire or a part of the illumination region IL or changing a hue thereof. Specifically, it is possible to prompt the driver to grip the steering device 100 by setting the entire or a part of the illumination region IL to red. The change in the brightness or hue of the illumination region IL by the illumination device 200 is not limited to the purpose of notifying the information described above, and may be simply a decorative change or a change for the purpose of shaking off sleepiness of the driver. The light emitted from the light source of the illumination device 200 is not limited to the visible light, and may be the infrared rays. In the present embodiment, the visible light and the infrared rays are emitted as described later. The infrared rays exit from the illumination region IL toward a driver's seat direction. The infrared rays are emitted to the body of the driver and are used to capture an image of a part of the body of the driver. By emitting the infrared rays from the steering device 100 to the driver in a dark vehicle cabin at night, it is possible to easily capture an image of a posture of the driver by an infrared camera without making the driver feel dazzled.

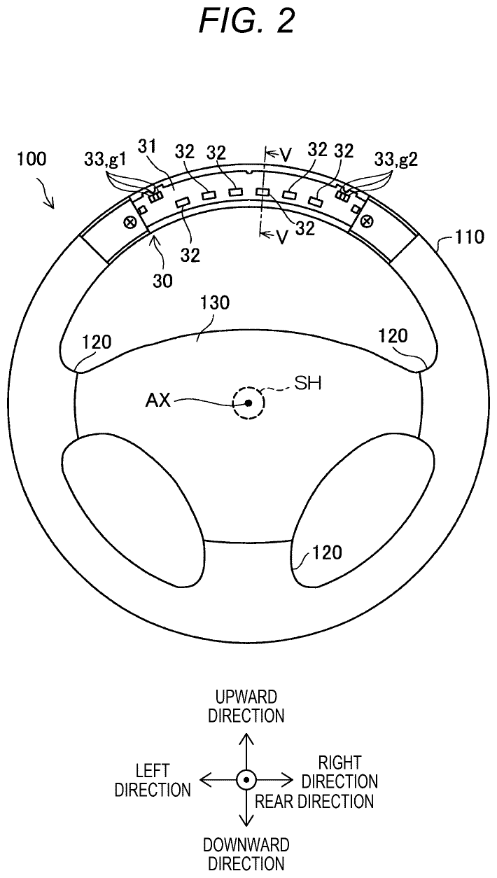

FIG. 2 is a plan view showing an external shape of the steering device 100 in a state in which a cover member 10, a light guiding member 20, and a housing member 40 are removed. As described below, in the illumination device 200, the cover member 10 having light transmission with respect to the visible light and the infrared rays is disposed at a position facing the driver, and the light guiding member 20 and the housing member 40, which will be described later, are disposed on the front direction side of the cover member 10. FIG. 2 schematically shows the steering device 100 in the state in which the cover member 10, the light guiding member 20, and the housing member 40 are removed.

As shown in FIG. 2, when the cover member 10, the light guiding member 20, and the housing member 40 are removed, a light emitting portion 30, which is one of components constituting the illumination device 200, is exposed. The light emitting portion 30 includes a substrate 31 and a plurality of light emitting elements provided on a surface of the substrate 31. In the present embodiment, the “plurality of light emitting elements” include a plurality of first LEDs 32 and a plurality of second LEDs 33, which are light sources. The substrate 31 has an arc-like and belt-like external shape that is curved along a circumferential direction of the grip portion 110 (hereinafter, also simply referred to as the “circumferential direction”) when viewed by the driver. Hereinafter, a radial direction (a direction orthogonal to the axis AX) of the grip portion 110 is also simply referred to as the “radial direction”. The plurality of first LEDs 32 are disposed at positions close to an end portion on the downward direction side of the surface of the substrate 31 on the rear direction side so as to be separated from each other by a predetermined distance along the circumferential direction. The first LEDs 32 emit the visible light. In the present embodiment, a visible light LED capable of emitting red light, green light, and blue light is used as the first LED 32.

On the other hand, the plurality of second LEDs 33 emit light in an infrared region. The plurality of second LEDs 33 form two groups g1 and g2 disposed to be separated from each other. Each of the groups g1 and g2 includes a plurality of second LEDs 33 adjacent to each other in the circumferential direction. Each of the two groups g1 and g2 is disposed at a position close to an end portion on the upward direction side of the surface of the substrate 31 on the rear direction side. The two groups g1 and g2 are disposed to be separated from each other so as to sandwich the plurality of first LEDs 32 when viewed along the circumferential direction.

### (A2) Detailed Configuration of Illumination Device 200

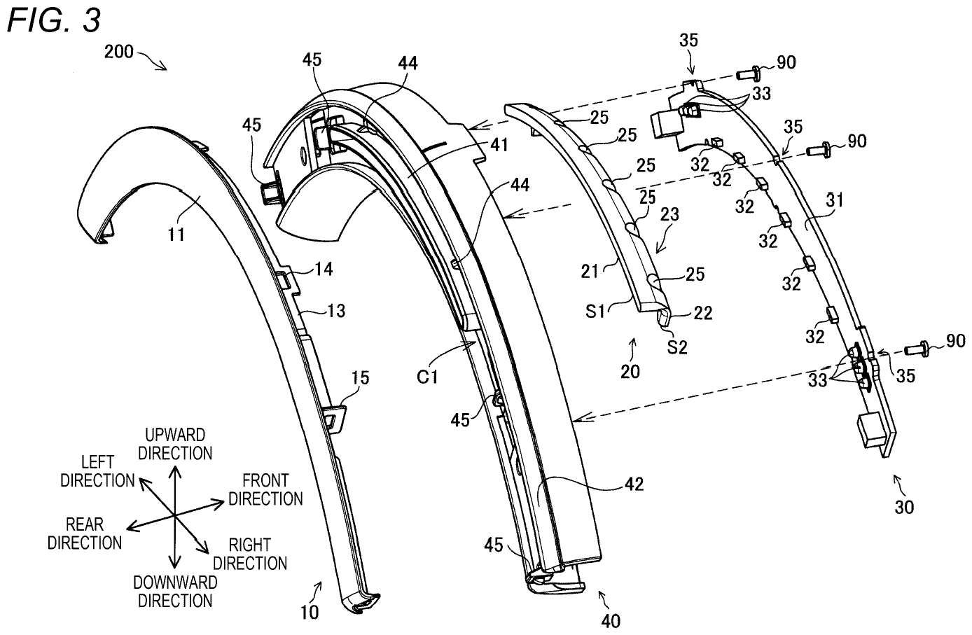

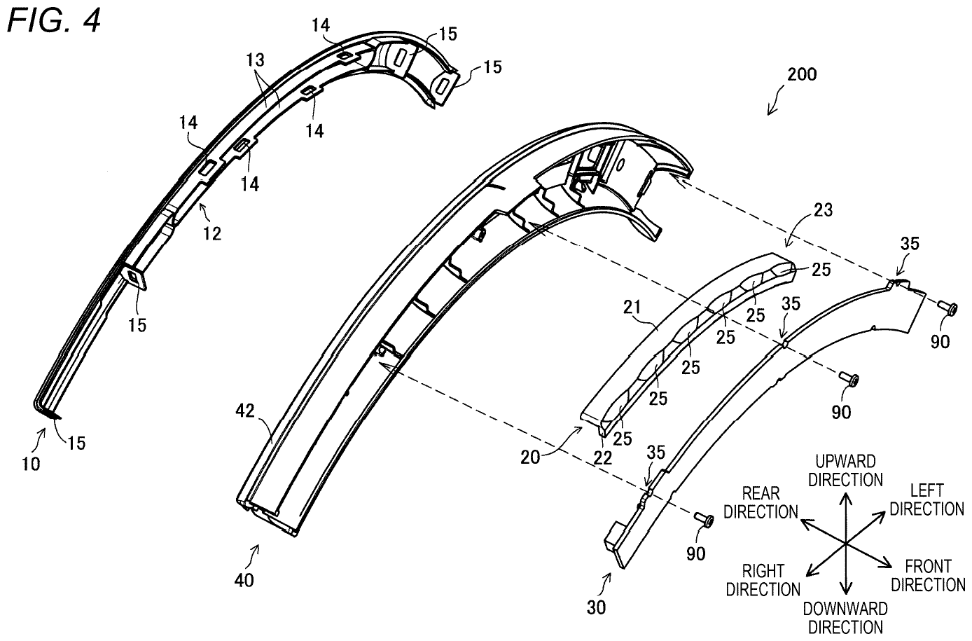

FIG. 3 is a first exploded perspective view showing a detailed configuration of the illumination device 200. FIG. 4 is a second exploded perspective view showing the detailed configuration of the illumination device 200. FIG. 3 corresponds to an exploded perspective view of the illumination device 200 viewed substantially from the rear side toward the front side. FIG. 4 corresponds to an exploded perspective view of the illumination device 200 viewed substantially from the front side toward the rear side.

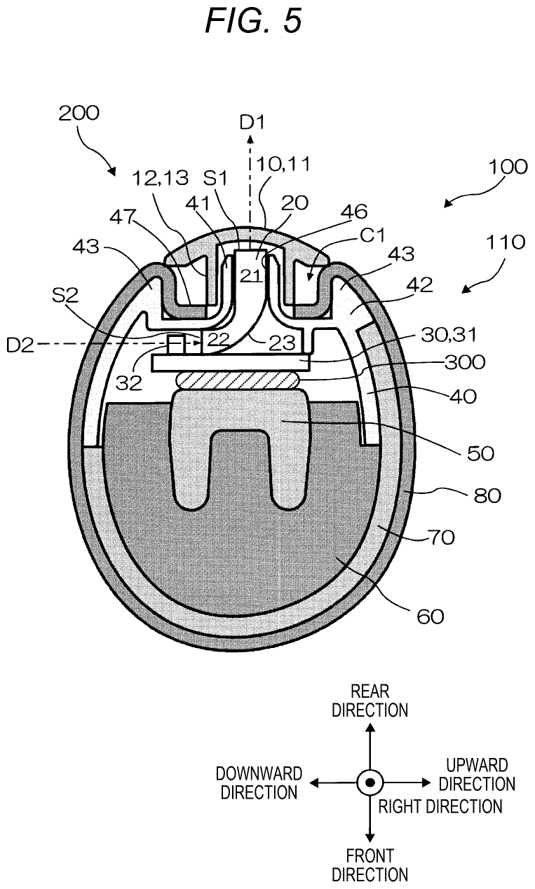

FIG. 5 is a cross section taken along a V-V line in FIG. 2, that is, a cross-sectional view showing a cross section of the grip portion 110 of the steering device 100. FIG. 5 shows a cross section at a position where the first LED 32 of the illumination device 200 is present as shown in FIG. 2, but for convenience of illustration, various cross sections are not drawn by hatching.

As shown in FIGS. 3 and 4, the illumination device 200 includes the cover member 10, the light guiding member 20, and the housing member 40 in addition to the light emitting portion 30 described above. The illumination device 200 has a structure in which the light guiding member 20 and the light emitting portion 30, and the cover member 10 are integrally assembled in the front-rear direction with the housing member 40 sandwiched therebetween. As shown in FIGS. 3 and 4, the light guiding member 20 has an arc-like external shape in accordance with disposed positions of the plurality of first LEDs 32 when viewed by the driver. The light guiding member 20 functions as a light guiding path that guides the light from the first LEDs 32 to the outside as described below.

As shown in FIGS. 3 and 4, the cover member 10 includes an outer surface forming portion 11, a surrounding portion 12, and a plurality of engaging walls 15. The outer surface forming portion 11 shown in FIG. 3 forms an outer surface of the steering device 100 continuously with the outer skin layer 80 as shown in FIG. 5. Similarly to the substrate 31 described above, the outer surface forming portion 11 has an arc-like and belt-like external shape that is curved along the circumferential direction of the grip portion 110 when viewed by the driver. The outer surface forming portion 11 is transparent to the visible light and the infrared rays. In the present embodiment, the outer surface forming portion 11 has a transmittance of about 25% with respect to the visible light and a transmittance of about 90% with respect to the infrared rays. Each of the transmittances with respect to the visible light and the infrared rays may be any value higher than 0%. In the present embodiment, the outer surface forming portion 11 is made of a black transparent synthetic resin in accordance with the black outer skin layer 80. The outer surface forming portion 11 has, in addition to a function of protecting the light emitting portion 30, a function of limiting a region through which the visible light emitted from the first LEDs 32 as the light source is transmitted (in other words, a function of masking a region other than the illumination region), and a function of deflecting an emission direction of the infrared rays emitted from the second LEDs 33 to be directed to the upper side on the rear direction side which is a driver side. Further, the outer surface forming portion 11 has a function of scattering, when the visible light incident from the first LEDs 32 exits to the outside, an exiting direction of the visible light.

As shown in FIG. 4, the surrounding portion 12 is provided on a surface (an inner surface) of the outer surface forming portion 11 on the front direction side. In a state in which the illumination device 200 is assembled (hereinafter, also simply referred to as an “assembled state”), the surrounding portion 12 is disposed to surround a support portion 41 protruding from the recess C1 of the housing member 40 shown in FIGS. 3 and 5 toward the rear direction side, and a first light guiding portion 21 (to be described later) corresponding to a part of the light guiding member 20 accommodated in the support portion 41 over the entire periphery. The recess C1 has a groove-shaped structure that opens into a surface of the housing member 40 in the front direction and extends along the circumferential direction. In the surrounding portion 12, a protrusion 13 corresponding to a side wall along the radial direction protrudes from the surface of the outer surface forming portion 11 on the front direction side, that is, the inner surface to a depth direction of the recess C1. In the present embodiment, the “depth direction of the recess C1” substantially coincides with the front-rear direction as evident from FIGS. 3 and 5. As shown in FIG. 4, a plurality of engaging holes 14 are formed in the protrusion 13. In the assembled state, engaging claws 44 (see FIG. 3) provided in an outer peripheral surface of the support portion 41 of the housing member 40 are engaged with the engaging holes 14. Such engagement is achieved by a series of operations, that is, when the cover member 10 is pushed into the housing member 40, the protrusion 13 is elastically deformed along the shape of the engaging claws 44, passes over the engaging claws 44 and returns to an original state, and thus the engaging claws 44 are fitted into the engaging holes 14. Such a structure in which one member is fixed to the other member by using elastic deformation of the one member is referred to as snap-fit. Similarly, as shown in FIG. 4, the plurality of engaging walls 15 provided in the cover member 10 have a wall-like shape that is elastically deformable and protrudes in the front direction, and engaging holes provided in the engaging walls 15 and engaging claws provided in engaging walls 45 are snap-fitted, respectively. Accordingly, the cover member 10 is fixed to the housing member 40.

The housing member 40 accommodates and holds the light guiding member 20 and the light emitting portion 30 attached to the front direction side thereof, and holds the cover member 10 attached to the rear direction side thereof. Details of an attachment state of the housing member 40, the light guiding member 20, and the light emitting portion 30 (the substrate 31) will be described later. As shown in FIGS. 3 and 4, the housing member 40 has an arc-like and belt-like external shape that is curved along the annular direction CW when viewed by the driver. In the present embodiment, the housing member 40 is configured as a single component made of an ABS resin. The housing member 40 may be configured as a single component made of a PC resin instead of the ABS resin or in addition to the ABS resin. Alternatively, the housing member 40 may be configured as a composite component obtained by combining a plurality of components. As described above, the recess C1 continuous in the annular direction CW is formed in a surface of the housing member 40 on the rear direction side. As shown in FIGS. 3 to 5, on a surface of the housing member 40 on the front direction side, a covering portion 42 continuous in the annular direction CW is provided on the upward direction side and the downward direction side with the recess C1 sandwiched therebetween. As shown in FIG. 5, a cross-sectional shape of an outer surface of the covering portion 42 is a shape in which an angle between a surface existing in the upward direction and a surface existing in the downward direction with a top portion 43 sandwiched therebetween is an acute angle. The covering portion 42 is covered with the outer skin layer 80 to be described later.

In the recess C1, a through hole 46 penetrating in the thickness direction is formed in a portion corresponding to the light guiding member 20. As shown in FIG. 5, the first light guiding portion 21 of the light guiding member 20 is inserted into the through hole 46. As shown in FIGS. 3 and 5, in the recess C1, the above support portion 41 is provided to surround the through hole 46 into which the first light guiding portion 21 is inserted. Similarly to the surrounding portion 12 of the cover member 10 shown in FIG. 4, the support portion 41 is formed to protrude in the rear direction so as to surround the through hole 46 and a side surface of the first light guiding portion 21 inserted into the through hole 46 over the entire periphery. As shown in FIG. 3, the support portion 41 has a flat cylindrical external shape curved to an arc shape. As described above, the plurality of engaging claws 44 are provided in the outer peripheral surface of the support portion 41, and the engaging claws 44 are engaged with the engaging holes 14 of the cover member 10 in the assembled state. The support portion 41 restrains a positional misalignment of the light guiding member 20 including the first light guiding portion 21 in the upward-downward direction and the left-right direction.

The first LEDs 32, the second LEDs 33, and the like of the illumination device 200 described above are mounted on the substrate 31 together with other electronic components. A power supply cable and a signal cable are connected to the substrate 31. The power supply cable is a cable for supplying necessary power from the outside, for example, a vehicle body. The signal cable is a cable through which an electronic control unit (ECU) and the like on a vehicle side and the substrate 31 exchange a control signal. Illustration of these cables is omitted. The control signal includes a signal for controlling blinking of the first LEDs 32, the second LEDs 33, or the like. The exchange of the control signal may be performed by short-range communication such as Bluetooth (registered trademark), and the supply of power may be performed by a non-contact power supply method using magnetic field coupling or the like.

### (A3) Detailed Configuration of Grip Portion 110

Next, a structure of the grip portion 110 will be described in detail. As described above, the illumination device 200 is accommodated in the grip portion 110, but the illumination device 200 is provided in a part (the position indicated as the illumination region IL in FIG. 1) of the grip portion 110 in the upward direction when the steering device 100 is in the reference state, and is not provided in other regions. A cross-sectional configuration of a portion in which the illumination device 200 is not mounted is the same as a cross-sectional configuration of the portion in which the illumination device 200 shown in FIG. 5 is mounted except that the illumination device 200 is not mounted.

As shown in FIG. 5, the grip portion 110 includes a cored bar 50, a core portion 60, an element layer 70, and the outer skin layer 80 over the entire periphery regardless of the presence or absence of the illumination device 200. In the present embodiment, the cored bar 50 is a member different from the housing member 40, and functions as a member that serves as a heat dissipation destination and receives heat transfer from a high-temperature portion. In the present embodiment, as shown in FIG. 5, a back surface of substrate 31 of the light emitting portion 30 and the cored bar 50 are joined by a heat transfer member 300, and heat generated in the first LEDs 32 and the second LEDs 33 mounted on substrate 31 is transferred to the cored bar 50 via the heat transfer member 300. As a result, the heat generated by the electronic components and the like mounted on the substrate 31 is dissipated to the cored bar 50, an increase in temperature of the substrate 31, and further an increase in temperature of the light emitting portion 30 are restrained.

The cored bar 50 is made of metal and is a member serving as a framework of the grip portion 110. In the present embodiment, the cored bar 50 is made of an aluminum alloy. The cored bar 50 may be made of any kind of metal such as a magnesium alloy and steel instead of the aluminum alloy. The core portion 60 is disposed to cover the entire cored bar 50 except for a surface H1 in the rear direction, and forms a core of the grip portion 110. The core portion 60 is made of a soft synthetic resin having a cushioning property. Specifically, in the present embodiment, the core portion 60 is made of a soft foamed material such as foamed polyurethane. The element layer 70 partially covers the core portion 60.

The element layer 70 is a layer provided with an electric heating wire constituting the heater and an electrode for detecting the gripping. For example, the element layer 70 is made of a conductive cloth obtained by performing a surface treatment such as carbon coating and metal plating to a fiber cloth. As shown in FIG. 5, the element layer 70 also covers a part of the housing member 40 at the portion of the grip portion 110 to which the illumination device 200 is attached. An outer surface of the element layer 70 and a part of an outer surface of the housing member 40 form a continuous curved surface. The outer skin layer 80 continuously covers the outer surface of the element layer 70, the outer surface of the covering portion 42 of the housing member 40, and the inside of the recess C1 of the housing member 40. As shown in FIG. 5, terminal portions of the leather member constituting the outer skin layer 80 are accommodated in the recess C1. The outer skin layer 80 is formed of the leather member. In the present embodiment, the leather member is made of natural leather such as a top leather and a split leather divided from the top leather. The leather member may be made of any kind of leather material such as synthetic leather and artificial leather instead of the natural leather.

The respective components of the steering device 100 described above are generally assembled according to the following procedure. First, the cover member 10, the light guiding member 20, the light emitting portion 30, and the housing member 40 are prepared. Then, the light guiding member 20 and the light emitting portion 30 are attached to a back surface (the front direction side in the assembled state) of the housing member 40. The light guiding member 20 and the light emitting portion 30 are fixed to the housing member 40 by screwing three screws 90 shown in FIGS. 3 and 4 into screw holes (not shown) provided in the housing member 40 while housing the screws 90 in cutout portions 35 provided in an upper edge portion of the substrate 31. A structure in which the light guiding member 20 and the light emitting portion 30 are assembled to the housing member 40 is hereinafter referred to as a subassembly.

Next, the subassembly is coupled to a cored bar 50 side. For this purpose, first, the core portion 60 and the element layer 70 are formed by a method such as two-color molding so as to surround the cored bar 50. Hereinafter, the member obtained in this manner is referred to as the “handle member”. By fastening the subassembly to the cored bar 50 using a screw (not shown), the leather member is wound around an outer surface of a member integrated with the handle member to form the outer skin layer 80. The outer skin layer 80 may be formed by, for example, winding a plurality of parts of the leather member in the circumferential direction. Subsequently, an adhesive is applied to a wall surface of the recess C1, the terminal portions of the outer skin layer 80 are bent along the shape of the covering portion 42 and are accommodated in the recess C1, and the terminal portions are adhered to the wall surface of the recess C1. Subsequently, the cover member 10 is fitted into the recess C1. The cover member 10 is fixed to the housing member 40 by the snap-fit described above. The steering device 100 according to the present embodiment is formed by coupling the grip portion 110 formed in this manner to the boss portion 130 via the spoke portions 120. A method or the procedure for forming the steering device 100 is not limited to the above, and an appropriate method or procedure may be adopted depending on the material, the structure, and the like of each component.

### (A4) Structure And Function of Light Guiding Member 20

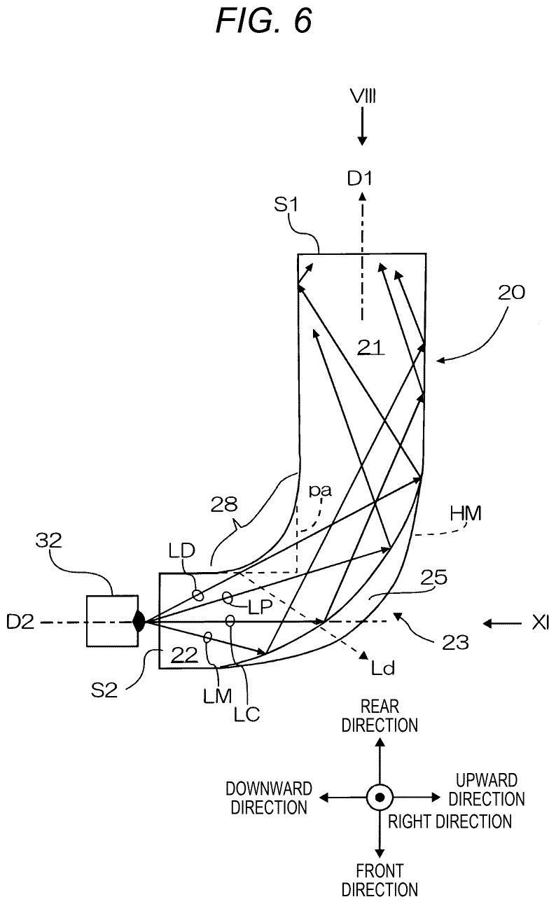

Next, a structure and a function of the light guiding member 20 guiding the light from the first LEDs 32 will be described mainly with reference to FIGS. 5 and 6. The light guiding member 20 guides the light (the visible light) emitted from the first LEDs 32 to the cover member 10. In the present embodiment, the light guiding member 20 is made of a polycarbonate (PC) resin. The light guiding member 20 may be made of an acrylic resin instead of the PC resin. In order to describe a direction of the light in the light guiding member 20, the rear direction in FIG. 5, that is, the direction from the center of the grip portion 110 toward the cover member 10 is hereinafter referred to as a first direction D1. A direction orthogonal to the first direction D1, that is, the upward direction in FIG. 5 is hereinafter referred to as a second direction D2.

As shown in FIG. 5, the light guiding member 20 has an external shape whose cross-sectional shape along the axis AX is a substantially J shape. The substantially J shape is a shape in which the first light guiding portion 21 along the first direction D1 and a second light guiding portion 22 shorter than the first light guiding portion 21 and along the second direction D2 are connected by an arc-shaped portion. In the present embodiment, the direction of the light incident on the light guiding member 20 from the first LEDs 32 is changed from the second direction D2 to the first direction D1 by reflection at a boundary surface between the arc-shaped portion and the outside thereof. Therefore, the arc-shaped portion is referred to as a changing portion 23. The length of the first light guiding portion 21 along the first direction D1 and the length of the second light guiding portion 22 along the second direction D2 are not limited.

As shown in FIGS. 3 to 5, the first light guiding portion 21 includes an emission surface S1 through which the visible light is emitted from the light guiding member 20 to the cover member 10. The second light guiding portion 22 has an incident surface S2 on which the visible light emitted from the first LEDs 32 is incident. As shown in FIG. 5, the incident surface S2 is located in the upward direction (the second direction D2) with respect to the first LEDs 32. The visible light emitted from the first LEDs 32 is incident on the incident surface S2. The second direction D2 corresponds to the upward direction and the substantially upward direction in the state of FIG. 5. In the present embodiment, the first direction D1 and the second direction D2 are orthogonal to each other, and may form an angle other than a right angle.

The changing portion 23 totally reflects the direction of the light incident from the first LEDs 32 by the boundary surface provided in a part of the outer periphery of the light guiding member 20 and roughly changes the direction from the second direction D2 to the first direction D1, and scatters the light to spread in a predetermined range in an adjacency direction of the plurality of first LEDs 32, that is, in the annular direction CW. In order to achieve such a change in the direction of the light from the first LEDs 32, the boundary surface provided in the part of the outer periphery of the light guiding member 20 is provided corresponding to the entire range of the plurality of first LEDs 32, that is, provided continuously in the annular direction CW, as shown in FIG. 4.

As shown in FIG. 4, a plurality of scattering and reflecting portions 25 are formed at positions corresponding to the first LEDs 32 on a boundary surface HM. Each scattering and reflecting portion 25 is disposed at a position corresponding to the corresponding first LED 32 on the front side, that is, on an optical axis of the corresponding first LED 32. Each scattering and reflecting portion 25 has a recessed structure in which a corresponding part of the changing portion 23 is chamfered. As shown in FIG. 5, in the assembled state, the first light guiding portion 21 is accommodated in the recess C1. On the other hand, in the assembled state, the second light guiding portion 22 and the changing portion 23 are located on the front direction side of the housing member 40, and are not accommodated in the recess C1.

The general shape of the light guiding member 20 including the scattering and reflecting portions 25 will be described below. On the optical axis passing through the center of each first LED 32, as shown in FIG. 5, the changing portion 23 to which the first light guiding portion 21 and the second light guiding portion 22 are connected is formed in a substantially arc shape connecting the first direction D1 and the second direction D2. As described above, each scattering and reflecting portion 25 has a concave surface shape in the annular direction CW, but has an arc shape continuing from the second light guiding portion 22 to the first light guiding portion 21 even though the scattering and reflecting portion 25 is separated from the optical axis passing through the center of the corresponding first LED 32. Therefore, the visible light incident on the second light guiding portion 22 from the incident surface S2 and running upward (in the second direction D2) is substantially totally reflected at the scattering and reflecting portions 25 of the changing portion 23, and thus a running direction of the light is changed such that the light runs in the rear direction (in the first direction D1), and the light is guided to the first light guiding portion 21. That is, the visible light incident on the second light guiding portion 22 is changed in the running direction by the changing portion 23, and is scattered in the annular direction CW and spread in the annular direction CW by the scattering and reflecting portions 25.

In this way, a path of the light incident from the first LEDs 32 is changed by the changing portion 23 in two points. One point is a path change from the second direction D2 to the first direction D1, and the other point is a path change in which the light running in the second direction D2 is spread in the annular direction CW. Hereinafter, the description will be made in this order.

FIG. 6 is an explanatory diagram showing a state in which, by using the first LEDs 32 and the light guiding member 20, the path of the light from the first LEDs 32 serving as the light source is changed from the second direction D2 to the first direction D1. The visible light emitted from the first LEDs 32 has the directivity unique to the first LEDs 32 and is emitted as a substantially conical light beam, and the center of the visible light, that is, the direction of the visible light which is take into consideration as much as possible is referred to as an emission direction of the light from the first LEDs 32. In this embodiment, the emission direction of the light from the first LEDs 32 is the second direction D2. The second direction D2 is substantially perpendicular to the incident surface S2 of the light guiding member 20.

Almost all the light emitted from the first LEDs 32 is incident to the second light guiding portion 22 from the incident surface S2, but the light emitted from the first LEDs 32 includes not only light incident in parallel to the second direction D2 but also light that has a certain degree of directivity and is incident to spread in a predetermined angle range with respect to the second direction D2 as shown in FIG. 6. Among the above light, light emitted from the first LEDs 32 toward the second direction D2 and incident on the second light guiding portion 22 is denoted by LC, light incident from the second direction D2 toward a side (the front direction side) opposite to the first direction D1 at a predetermined inclination angle is denoted by LM, light incident from the second direction D2 toward the first direction D1 side (the rear direction side) at a predetermined inclination angle is denoted by LP, and light incident toward the first direction D1 at a larger inclination angle than that of the light LP is denoted by LD, and these lights are shown in FIG. 6. When these lights are distinguished, these reference numerals are used to represent these lights, like emitted light PC.

In the present embodiment, the changing portion 23 of the light guiding member 20 has an arc-shaped cross section when the light guiding member 20 is cut along a plane passing through an emission center of the light from the first LEDs 32 and including the first direction D1 and the second direction D2. The outer periphery of this arc shape, that is, a side having a large curvature radius serves as the changing portion 23 that changes the direction of the light incident on the second light guiding portion 22. The changing portion 23 has a boundary surface between the light guiding member 20 having a high refractive index and air having a low refractive index, and light incident at an angle equal to or larger than a critical angle is totally reflected. The material of the light guiding member 20 according to the present embodiment is polycarbonate, and a refractive index thereof is 1.59. Therefore, the critical angle ζ at which the total reflection occurs is ζ=sin⁻¹ (1/1.56)≈39 degrees. Therefore, when an incident angle, which is an angle with respect to a normal line at a point where the incident light reaches the arc-shaped boundary surface HM of the changing portion 23, is larger than 39 degrees, the total reflection occurs, the incident light is hardly lost, and the direction of the incident light is changed toward the first direction D1.

In the light guiding member 20 according to the present embodiment, since the refractive index of the light guiding member 20 is high and the changing portion 23 has an arc shape, all of the incident lights LC, LM, LP, and LD are totally reflected by the boundary surface HM of the changing portion 23, and light paths thereof are changed to the first direction D1. The shape of the boundary surface HM for totally reflecting each incident light will be described in detail later. The lights after the total reflection reach the emission surface S1 directly or by being repeatedly reflected at the boundary surface HM located at the outer periphery of the first light guiding portion 21, and the lights exit to the outside while being refracted at the emission surface S1. The lights exiting from the emission surface S1 exit from the illumination device 200.

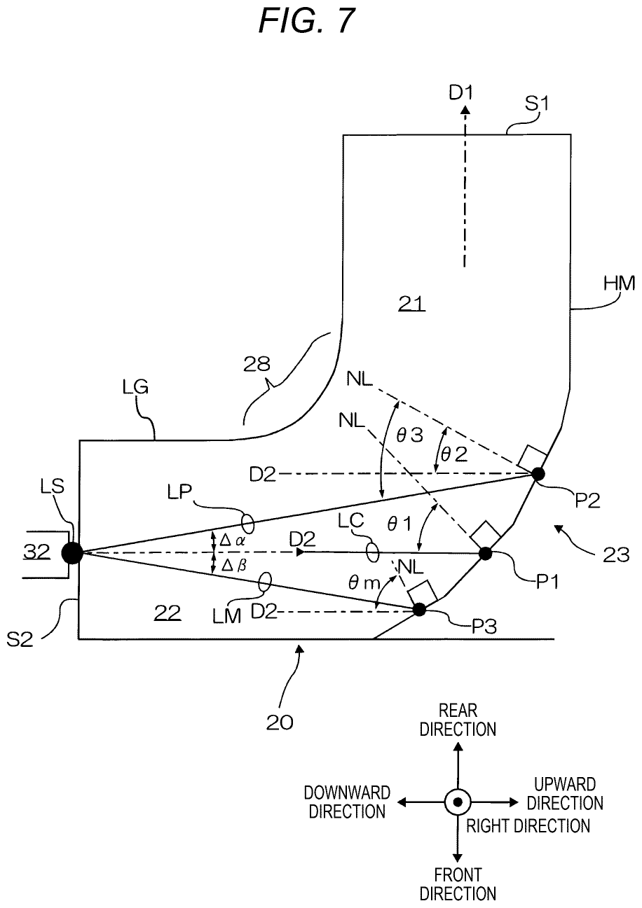

The reason why most of the light incident on the incident surface S2 of the second light guiding portion 22 of the light guiding member 20 is totally reflected by the changing portion 23 is that the changing portion 23 has a shape described below. FIG. 7 is an explanatory diagram schematically illustrating a state of the reflection at the changing portion 23. Although the changing portion 23 actually has the arc shape as shown in FIG. 6, for convenience of description, in FIG. 7, the changing portion 23 is schematically shown as a polygonal shape obtained by connecting tangents at points P1, P2, and P3 where the incident light reaches. In FIG. 7, the point P1 indicates a position where the light LC incident in the second direction D2 through the center of the first LED 32 reaches the outer periphery of the light guiding member 20 at the changing portion 23. Similarly, the point P2 indicates a position where the light LP emitted from the first LED 32 and inclined toward the first direction D1 side by a displacement angle Δα with respect to the second direction D2 reaches the outer periphery of the light guiding member 20 at the changing portion 23. Further, the point P3 indicates a position where the light LM emitted from the first LED 32 and inclined toward a side opposite to the first direction D1 side by the displacement angle Δα with respect to the second direction D2 reaches the outer periphery of the light guiding member 20 at the changing portion 23.

In the present embodiment, the boundary surface HM of the changing portion 23 in which the points P1, P2, and P3 are defined satisfies the following relation. That is, in the boundary surface HM of the changing portion 23, a first angle θ1 which is an incident angle at the point P1 on the boundary surface HM, and an inclination angle θ2 formed by a normal line NL at the point P2 with respect to the second direction D2 satisfy the following relation.
[1] When the incident angle at the first point P1, which is a point on the boundary surface HM where the light emitted from the first LED 32 as the light source in the second direction D2 is reflected toward the first direction D1, is set to the first angle θ1 satisfying a total reflection condition, and
[2] when the inclination angle at the second point P2, which is a point where the light inclined by the predetermined displacement angle Δα in the first direction D1 with respect to the second direction D2 among the light emitted from the first LED 32 is reflected toward the first direction D1, is set to the second angle θ2,
<1> the second angle θ2 is smaller than the first angle θ1, and
<2> a deviation Δθ between the first angle θ1 and the second angle θ2 is equal to or smaller than the displacement angle Δα.

The boundary surface HM of the changing portion 23 of the light guiding member 20 in the illumination device 200 according to the present embodiment satisfies the above relation. Here, when <1> and <2> described above are expressed by equations,

$$θ1 - θ 2 = Δ θ > 0 ; \qquad < 1 >$$

and
<2> Δθ<Δα. Based on this relation, by using the fact that an incident angle θ3 toward the second point P2 satisfies θ3=θ2+Δα, it is derived that θ3−θ1≥0. That is, when the above condition is satisfied, the incident angle θ3 at the second point P2 is equal to or larger than the incident angle θ1 at the first point P1, and when the total reflection condition is satisfied at the first point P1, the total reflection condition is also satisfied at the second point P2.

This relation related to the total reflection condition is similarly established as long as an inclination angle θm at the third point P3, which is a point where the light LM inclined toward the side opposite to the first direction D1 side by a predetermined displacement angle Δβ with respect to the second direction D2 among the light emitted from the first LED 32 as the light source is reflected toward the first direction D1 on the boundary surface HM, is larger than the first angle θ1, and a deviation between the inclination angle θm and the first angle θ1 is equal to or smaller than the displacement angle Δβ.

In the present embodiment, in the arc shape of the changing portion 23 of the light guiding member 20, the relation between the first angle θ1 as the incident angle at the first point P1 on the boundary surface HM and the second angle θ2 at the second point P2 shifted from the first point P1 toward the first direction D1 is as described above, and thus when the light emitted from the first LED 32 with a predetermined spread (directivity) enters the changing portion 23, the total reflection condition is satisfied at the first point P1, and as a result, the total reflection condition is also satisfied at the second point P2, and it is possible to restrain a loss of light at the time of reflection at the boundary surface HM of the changing portion 23. Further, since the shape of the changing portion 23 is selected to satisfy the above condition also at the third point P3, the loss of light at the time of reflection at the boundary surface HM of the changing portion 23 is similarly restrained.

### (A5) Light Scattering at Scattering and Reflecting Portions 25

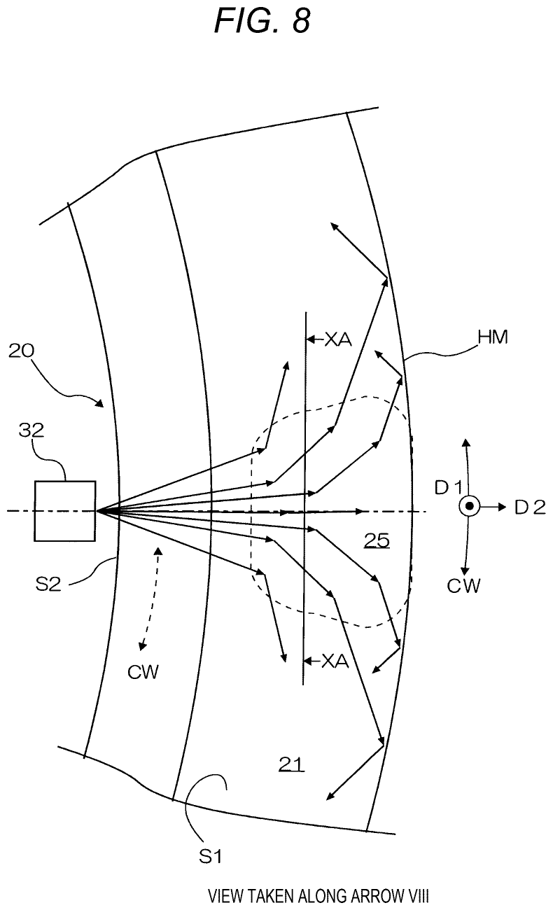

Next, light scattering by the scattering and reflecting portions 25 will be described with reference to FIGS. 8 to 10B. As described above, the scattering and reflecting portions 25 are provided on the boundary surface HM of the changing portion 23 to scatter the light from the first LEDs 32 mainly in the annular direction CW and guide the light to a wide range of the illumination region IL by a small number of first LEDs 32.

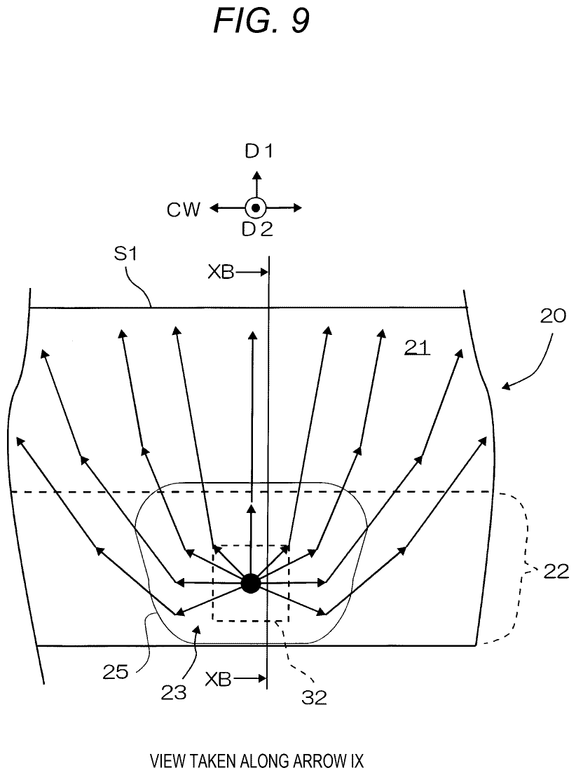

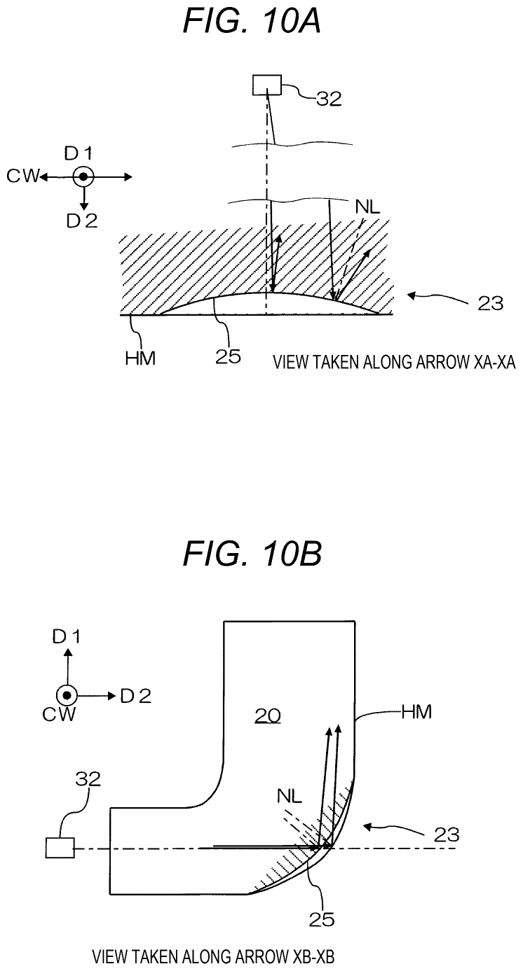

FIG. 8 is a view taken along an arrow VIII in FIG. 6, and FIG. 9 is a view taken along an arrow IX in FIG. 6. Further, FIG. 10A on the upper side is a view taken along an arrow XA-XA in FIG. 8, and FIG. 10B on the lower side is a view taken along an arrow XB-XB in FIG. 9. As shown in FIGS. 8 to 10B, each scattering and reflecting portion 25 has a shape recessed inward with a predetermined curvature with respect to the boundary surface HM at the outer periphery of the changing portion 23. For this reason, as shown in FIGS. 8 and 9, the light incident on the scattering and reflecting portion 25 is largely scattered and spread as the light shifts from the center of the corresponding first LED 32 in the left-right direction, and exits from the emission surface S1 to the outside. As shown in FIG. 10A, the light incident on the scattering and reflecting portion 25 is scattered and spread in the annular direction CW according to a curved surface.

As shown in FIG. 10A, when the light from the first LED 32 is displaced in the left-right direction and is incident on the scattering and reflecting portion 25, a degree of scattering in the left-right direction increases as the light is separated from the center in the left-right direction due to a difference in emission angles of the first LED 32 in the left-right direction and a difference in angles with respect to the normal line NL due to the curvature of the scattering and reflecting portion 25, and the light from the first LED 32 is widely scattered in the annular direction CW in the illumination region IL. On the other hand, as shown in FIG. 10B, a degree of scattering in the upward-downward direction of the light scattered by the scattering and reflecting portion 25 is relatively small and falls within a width range of the illumination region IL. As a result, the wide illumination region IL can be relatively uniformly illuminated by the plurality of first LEDs 32 arranged at intervals.

### (A6) Shape and Role of Connecting Shape Portion 28

In the present embodiment, an inner side of the changing portion 23 having the arc shape, that is, a side having a small curvature radius (hereinafter, referred to as a connecting shape portion 28) has an arc shape following the outer shape. When the inner shape is a corner portion shape pa that is bent at a right angle instead of the arc-shaped connecting shape portion 28, as shown in FIG. 6, the incident light LD is reflected at the corner portion shape pa, and is not totally reflected at the boundary surface HM of the changing portion 23 and exits to the outside as shown by a broken line Ld. Since the light exiting to the outside does not reach the emission surface S1, the amount of light as the illumination device 200 decreases accordingly. In the present embodiment, since the connecting shape portion 28 also has the arc shape, the occurrence of such loss can be reduced, and the brightness of the illumination device 200 can be increased accordingly, or power consumption can be restrained as compared with an illumination device having the same brightness in the related art.

In the present embodiment, the shape of the connecting shape portion 28 follows the outer peripheral shape of the changing portion 23, but since the connecting shape portion 28 does not need to totally reflect the light and change the running direction of the light, the shape thereof may be any shape as long as the shape does not hinder the running of the light emitted from the first LEDs 32 as much as possible. As compared with the corner portion shape pa, any shape with less protrusion contributes to an increase in the amount of light emitted from the emission surface S1. For example, the shape may be a shape in which a corner portion of the corner portion shape pa is obliquely cut, a simple semicircular shape, or the like. That is, at least a part of the connecting shape portion 28 may have a shape that is inclined and is connected from the second direction toward the first direction. When the connecting shape portion 28 has a shape with less protrusion than the corner portion shape pa, a narrow portion is not generated in a passage cross-sectional area of the light guiding member 20, and this is also a factor that makes it easy to secure the amount of light.

### (A7) Operation and Effects

As described above, in the present embodiment, the shape of the changing portion 23 is set to a shape in which the total reflection at the boundary surface HM is likely to occur as described in detail in (A5), the connecting shape portion 28 is set to the shape with less protrusion, the light leaking to the outside from the changing portion 23 due to the reflection at the connecting shape portion 28 is reduced accordingly, a narrow portion is less likely to be formed in the light guiding member 20, and the like, and thus the combination of these facts allow to increase the proportion of light incident from the incident surface S2 and emitted from the emission surface S1 in the entire light guiding member 20. Accordingly, the brightness of the illumination region IL can be increased. Needless to say, instead of increasing the amount of light, the amount of light emission of the first LEDs 32 may be reduced to reduce power required to secure the same amount of light. If the power can be reduced, heat generation, aging deterioration, and the like in the first LEDs 32 can be restrained.

In the present embodiment, the scattering and reflecting portions 25 each having the recessed shape are formed on the boundary surface HM in the changing portion 23, but the recessed shape of each scattering and reflecting portion 25 is preferably recessed with a predetermined curvature radius in the annular direction CW and preferably follows the arc shape of the boundary surface HM of the changing portion 23. This is because, since the illumination region IL has an elongated shape in the annular direction CW, a degree of scattering of the light in the second direction D2 may be smaller than that in the annular direction CW. In the present embodiment, as shown in FIG. 6, the scattering and reflecting portion 25 has a shape recessed inside the light guiding member 20 with respect to a part of the boundary surface HM excluding the scattering and reflecting portion 25, but the scattering and reflecting portion 25 still has an outwardly convex arc shape. That is, in the present embodiment, each scattering and reflecting portion 25 has a so-called saddle shape. Needless to say, similarly to the annular direction CW, the scattering and reflecting portion 25 may also have a concave shape in a direction intersecting the annular direction CW, or may have a flat shape to widen a scattering range in the second direction.

In the above description, the first LEDs 32 are taken as an example of the light source, and the same also applies to the second LEDs 33. Whether the reflection of the infrared light emitted from the second LEDs 33 at the changing portion 23 of the light guiding member 20 satisfies the total reflection condition is substantially the same as the case of the visible light because a difference in the critical angle depending on a wavelength is slight, and the shape of the boundary surface HM may be determined similarly to the case of the visible light.

### B. Other Embodiments

(1) An aspect of another embodiment of the present disclosure can be implemented in the form of an illumination device that emits light in directions centered on a first direction. The illumination device includes: a light source that emits light centered on a second direction different from the first direction; and a light guiding path on which the light from the light source is incident that includes, at a part of an outer periphery thereof on a side opposite to the light source, a boundary surface reflecting the light incident in the second direction toward the first direction. Here, in the boundary surface by which the light emitted from the light source in the second direction is reflected toward the first direction, a first angle (θ1) serving as an incident angle at a first point (P1) on the boundary surface satisfies a total reflection condition, an angle formed by a normal line (NL) on the boundary surface with respect to the second direction is defined as an inclination angle, and for light inclined by a predetermined displacement angle (Δα) from the second direction toward the first direction being reflected by the boundary surface toward the first direction among the light emitted from the light source, a second angle (θ2) serving as the inclination angle formed at a second point (P2) on the boundary surface is smaller than the first angle, and a deviation (Δθ) between the first angle and the second angle is equal to or less than the displacement angle. Accordingly, since the incident angle of the light incident on the second point P2 satisfies the total reflection condition, it is possible to reduce a loss at the time of changing the direction of the light in the light guiding path by the reflection on the boundary surface. As a result, the light from the light source can be efficiently emitted from the illumination device toward the first direction. Therefore, it is possible to increase the amount of light from the illumination device or reduce energy required for emitting the light from the light source instead of increasing the amount of light, and it is possible to restrain an increase in temperature or deterioration of the light source.

Here, as long as the first point is a point at which the light emitted from the light source in the second direction is reflected toward the first direction, and the second point is a point on the boundary surface by which the light inclined by the predetermined displacement angle in the first direction is reflected from the second direction toward the first direction, other positional relations are not limited. Although it is assumed that an unlimited number of the first point and the second point are disposed, the above relation may be satisfied for one pair of the first point and the second point. Needless to say, the shape of the boundary surface may be determined such that the above relation is enhanced with a plurality of possible reflection points on the boundary surface as the second points.

Such a shape of the boundary surface may include a plurality of flat surfaces or may include one or more curved surfaces, as long as the above condition is satisfied. The shape may be formed by combining a flat surface and a curved surface. Accordingly, the boundary surface can be designed and manufactured in accordance with the directivity or the like of the light emitted from the light source, and various illumination devices that efficiently emit light can be achieved.

(2) In the above configuration, on the boundary surface, a third angle serving as the inclination angle at a third point may be larger than the first angle, the third point being a point at which light inclined by a predetermined displacement angle Δβ to a side opposite to the first direction with respect to the second direction is reflected toward the first direction among the light emitted from the light source, and a deviation between the third angle and the first angle may be equal to or less than the displacement angle Δβ. Accordingly, the light emitted from the light source for emitting the light centered on the second direction and inclined by the displacement angle Δβ in the direction opposite to the first direction can also be totally reflected by the boundary surface, and the light from the light source can be efficiently used.

(3) In the above configuration, a connecting shape portion inclined and connected from the second direction toward the first direction at a part of the outer periphery of the light guiding path on a side opposite to the boundary surface may be included. Accordingly, the connecting shape portion is inclined at the part of the outer periphery of the light guiding path on the side opposite to the boundary surface, and it is possible to reduce light reflected by a surface present along the second direction on the side opposite to the boundary surface among the light from the light source. Therefore, light that is not totally reflected at the boundary surface can be reduced, and the light from the light source can be used more efficiently.

(4) A second aspect of another embodiment of the present disclosure is an illumination device that emits light in directions centered on a first direction. The illumination device includes: a light source that emits light centered on a second direction different from the first direction; and a light guiding path on which the light from the light source is incident that includes, at a part of an outer periphery thereof on a side opposite to the light source, a boundary surface reflecting the light incident in the second direction toward the first direction. Here, in the boundary surface by which the light emitted from the light source in the second direction is reflected toward the first direction, a first angle (θ1) serving as an incident angle at a first point (P1) on the boundary surface satisfies a total reflection condition, and at least a part of a connecting shape portion (28) located on a side opposite to the boundary surface at a part of the outer periphery of the light guiding path has a shape that is inclined and connected from the second direction toward the first direction. Accordingly, the connecting shape portion is inclined at the part of the outer periphery of the light guiding path on the side opposite to the boundary surface, and it is possible to reduce light reflected by a surface present along the second direction on the side opposite to the boundary surface among the light from the light source. Therefore, light that is not totally reflected at the boundary surface can be reduced, and the light from the light source can be used efficiently.

A shape of a reflection surface of such an illumination device may have the features of (1) and (2) described above. Accordingly, light that is totally reflected at the boundary surface can be increased, and the light from the light source can be used more efficiently.

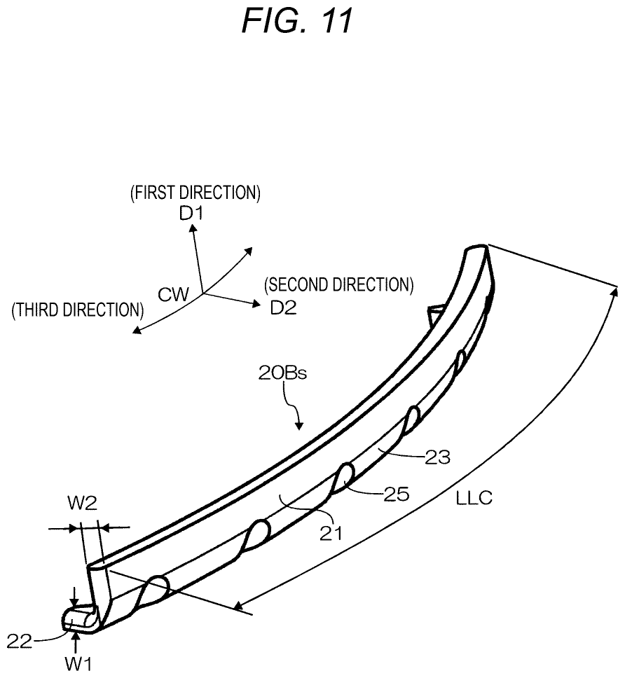

(5) In the above configuration, as shown in FIG. 11, a light guiding member 20B functioning as the light guiding path may be formed as follows. FIG. 11 is an explanatory diagram showing an example of the light guiding member 20B by a perspective view, and illustrating dimensions and the like of each portion. The light guiding member 20B is formed of the same material and in the same shape as those in the first embodiment, and the first direction D1 and the second direction D2 are substantially orthogonal to each other. The light guiding member 20B functioning as the light guiding path includes the first light guiding portion 21 that guides the light reflected by the boundary surface along the first direction D1, the second light guiding portion 22 that guides the light from the light source along the second direction D2, and the changing portion 23 that connects the first light guiding portion 21 and the second light guiding portion 22, and changes the direction of the light incident on the second light guiding portion 22 from the light source and guided toward the second direction D2 to the first direction D1. Here, a length LLC of the light guiding path along the third direction CW, which is a direction substantially orthogonal to the second direction D2 and the first direction D1, may be twice or larger than a width W1 of the second light guiding portion 22 in the first direction D1 and a width W2 of the first light guiding portion 21 in the second direction D2, and the changing portion 23 may include the scattering and reflecting portions 25 that scatter the light guided from the light source along the second direction D2 in the third direction CW. Accordingly, the light from the light source can be widely scattered in the third direction CW and can be emitted to the outside.

(6) In the above configuration, a plurality of light sources arranged along the third direction may be provided separated from one another. Accordingly, an unevenness of the light scattered in the third direction and emitted to the outside can be reduced.

(7) The present disclosure can also be implemented as a steering device. The steering device includes a substantially circular handle that is used to perform a steering operation, and an illumination device according to any one of (1) to (6) described above. Here, the first direction in the illumination device may be a direction from the handle toward a user who performs the steering operation, the second direction may be a radial direction toward the outside of the handle, and the third direction may be a circumferential direction of the handle. Accordingly, it is possible to provide a steering device that includes an illumination device capable of emitting light toward a user who performs a steering operation over a wide range in a circumferential direction of a handle.

The present disclosure is not limited to the embodiments described above, and may be implemented by various configurations without departing from the gist of the present disclosure. For example, technical features in the embodiments corresponding to technical features in aspects described in the summary of the invention may be replaced or combined as appropriate to solve a part or all of the above problems or to achieve a part or all of the above effects. Further, unless the technical features are described as being essential in the present specification, the technical features can be appropriately deleted. For example, a part of the configuration achieved by hardware in the above embodiments can be achieved by software.

What is claimed is:

1. An illumination device for emitting light in directions centered on a first direction, the illumination device comprising:
a light source configured to emit light centered on a second direction, the second direction being different from the first direction; and
a light guiding path on which the light from the light source is incident that includes, at a part of an outer periphery thereof on a side opposite to the light source, a boundary surface reflecting the light incident in the second direction toward the first direction, wherein
in the boundary surface by which the light emitted from the light source in the second direction is reflected toward the first direction,
a first angle serving as an incident angle at a first point on the boundary surface satisfies a total reflection condition,
an angle formed by a normal line on the boundary surface with respect to the second direction is defined as an inclination angle, and
for light inclined by a predetermined displacement angle from the second direction toward the first direction being reflected by the boundary surface toward the first direction among the light emitted from the light source, a second angle serving as the inclination angle formed at a second point on the boundary surface is smaller than the first angle, and a deviation between the first angle and the second angle is equal to or less than the displacement angle.

2. The illumination device according to claim 1, wherein
on the boundary surface, a third angle serving as the inclination angle at a third point is larger than the first angle, the third point being a point at which light inclined by a predetermined displacement angle to a side opposite to the first direction with respect to the second direction is reflected toward the first direction among the light emitted from the light source, and
a deviation between the third angle and the first angle is equal to or less than the displacement angle.

3. The illumination device according to claim 1, further comprising:
a connecting shape portion inclined and connected from the second direction toward the first direction at a part of the outer periphery of the light guiding path on a side opposite to the boundary surface.

4. An illumination device for emitting light in directions centered on a first direction, the illumination device comprising:
a light source configured to emit light centered on a second direction different from the first direction; and
a light guiding path on which the light from the light source is incident that includes, at a part of an outer periphery thereof on a side opposite to the light source, a boundary surface reflecting the light incident in the second direction toward the first direction, wherein
in the boundary surface by which the light emitted from the light source in the second direction is reflected toward the first direction, a first angle serving as an incident angle at a first point on the boundary surface satisfies a total reflection condition, and
at least a part of a connecting shape portion located on a side opposite to the boundary surface at a part of the outer periphery of the light guiding path has a shape that is inclined and connected from the second direction toward the first direction.

5. The illumination device according to claim 1, wherein
the boundary surface includes a plurality of flat surfaces, or one or more curved surfaces.

6. The illumination device according to claim 1, wherein
the first direction and the second direction are substantially orthogonal to each other,
the light guiding path includes
a first light guiding portion that guides the light reflected by the boundary surface along the first direction,
a second light guiding portion that guides the light from the light source along the second direction, and
a changing portion that connects the first light guiding portion and the second light guiding portion, and changes the direction of the light incident on the second light guiding portion from the light source and guided toward the second direction to the first direction,
a length of the light guiding path in a third direction substantially orthogonal to the second direction and the first direction is twice or larger than a width of the second light guiding portion in the first direction and a width of the first light guiding portion in the second direction, and
the changing portion includes a scattering and reflecting portion that scatters the light guided from the light source along the second direction in the third direction.

7. The illumination device according to claim 6, wherein
a plurality of light sources arranged along the third direction are provided separated from one another.

8. A steering device comprising:
a substantially circular handle configured to be used to perform a steering operation, and
the illumination device according to claim 6, wherein
the first direction is a direction from the handle toward a user who performs the steering operation,
the second direction is a radial direction toward the outside of the handle, and
the third direction is a circumferential direction of the handle.
